(19) United States
(12) Patent Application Publication
(10) Pub. No.: US 2002/0045267 A1
(43) Pub. Date: Apr. 18, 2002

(54) Protein dyeing and detecting method

(76) Inventors: Tohru Tsuchiya, Kanagawa-ken (JP); Makiko Nagashima, Tokyo (JP)

Correspondence Address: SUGHRUE MION, PLLC, 2100 Pennsylvania Avenue, NW, Washington, DC, 20037-3213, US

(21) Appl. No.: 09/982,881

(22) Filed: Oct. 22, 2001

Related U.S. Application Data
(63) Continuation of application No. 09/152,310, filed on Sep. 14, 1998.

(30) Foreign Application Priority Data
Sep. 19, 1997 (JP) 254582/1997

(51) Int. Cl. G01N 21/76

(52) U.S. Cl. 436/86; 436/172

(57) ABSTRACT

A protein dyeing and detecting method includes steps of fixing a protein electrophoresed on a gel on the gel using a fixing solution, dyeing the fixed protein with fluorescent dye for dyeing a protein which has a property of mainly acting on sodium dodecyl sulfide (SDS)-protein complex to dye a protein, irradiating the dyed protein with a stimulating ray and detecting fluorescent light emitted from the protein upon being irradiated to produce a fluorescent image of a protein, the fluorescent dye for dyeing a protein being most effectively stimulated with a stimulating ray having a wavelength between 440 nm to 500 nm or a wavelength between 510 nm to 580 nm and emitting fluorescent light whose peak wavelength ranges from 560 nm to 620 nm or from 600 nm to 660 nm. According to the thus constituted protein dyeing and detecting method, it is possible to produce a fluorescent image of a protein having high sharpness and low background noise.

### BACKGROUND OF THE INVENTION

The present invention relates to a protein dyeing and detecting method and, particularly, to such a method which can produce a fluorescent image of a protein having high sharpness and low background noise by dyeing an electrophoresed protein with fluorescent dye for dyeing a protein, irradiating it with a stimulating ray and detecting fluorescent light emitted therefrom upon being irradiated and can detect locational information of a protein with high sensitivity.

### DESCRIPTION OF THE PRIOR ART

A fluorescence system using a fluorescent substance as a labeling substance is known. According to this system, it is possible to study a genetic sequence, the expression level of a gene and to effect separation or identification of protein or estimation of the molecular weight or properties of protein or the like. For example, this system can perform a process including the steps of distributing a plurality of DNA fragments on a gel support by means of electrophoresis after a fluorescent dye was added to a solution containing a plurality of DNA fragments to be distributed or distributing a plurality of DNA fragments on a gel support containing a fluorescent dye or dipping a gel support on which a plurality of DNA fragments have been distributed by means of electrophoresis in a solution containing a fluorescent dye, thereby labeling the electrophoresed DNA fragments, exciting the fluorescent dye by a stimulating ray to cause it to release fluorescent light, detecting the released fluorescent light to produce an image and detecting the distribution of the DNA fragments on the gel support. This system can also perform a process including the steps of distributing a plurality of DNA fragments on a gel support by means of electrophoresis, denaturing the DNA fragments, transferring at least a part of the denatured DNA fragments onto a transfer support such as a nitrocellulose support by the Southern-blotting method, hybridizing a probe prepared by labeling target DNA and DNA or RNA complementary thereto with the denatured DNA fragments, thereby selectively labeling only the DNA fragments complementary to the probe DNA or probe RNA, exciting the fluorescent dye by a stimulating ray to cause it to release fluorescent light, detecting the released fluorescent light to produce an image and detecting the distribution of the target DNA on the transfer support. This system can further perform a process including the steps of preparing a DNA probe complementary to DNA containing a target gene labeled by a labeling substance, hybridizing it with DNA on a transfer support, combining an enzyme with the complementary DNA labeled by a labeling substance, causing the enzyme to contact a fluorescent substance, transforming the fluorescent substance to a fluorescent substance having fluorescent light releasing property, exciting the thus produced fluorescent substance by a stimulating ray to release fluorescent light, detecting the fluorescent light to produce an image and detecting the distribution of the target DNA on the transfer support. This fluorescence detecting system is advantageous in that a genetic sequence or the like can be easily detected without using a radioactive substance.

In such a fluorescence detecting system, it is known to produce a fluorescent image of a protein by dyeing an electrophoresed protein with a fluorescent dye for dyeing a protein which is most effectively stimulated with a stimulating ray having a wavelength between 440 nm to 500 nm, emits fluorescent light whose peak wavelength ranges from 560 nm to 620 nm and has a property of mainly acting on sodium dodecyl sulfide (SDS)-protein complex to dye the protein or a fluorescent dye for dyeing a protein which is most effectively stimulated with a stimulating ray having a wavelength between 510 nm to 580 nm and emits fluorescent light whose peak wavelength ranges from 600 nm to 660 nm, such as SYPRO Orange and SYPRO Red manufactured and sold by Molecular Probes Inc., Oregon, the U.S.A., irradiating it with a stimulating ray and detecting emitted fluorescent light and to detect locational information of the protein.

However, when a fluorescent image of a protein is produced in this manner, a fluorescent image having high sharpness cannot be obtained and since background noise is too high to detect the locational information of a protein with high sensitivity.

### SUMMARY OF THE INVENTION

It is therefore an object of the present invention is to provide a protein dyeing and detecting method which can produce a fluorescent image of a protein having high sharpness and low background noise by dyeing an electrophoresed protein with fluorescent dye for dyeing a protein, irradiating it with a stimulating ray and detecting fluorescent light emitted therefrom upon being irradiated and can detect locational information of a protein with high sensitivity.

Studies conducted by the inventors revealed the unexpected fact that a fluorescent image of a protein having high sharpness and low background noise can be produced and the sensitivity for detecting locational information of a protein can be markedly improved by fixing a protein electrophoresed on a gel on the gel using a fixing solution, dyeing the fixed protein with fluorescent dye for dyeing a protein which has a property of mainly acting on sodium dodecyl sulfide (SDS)-protein complex to dye a protein, irradiating the dyed protein with a stimulating ray and detecting fluorescent light emitted from the protein upon being irradiated to produce a fluorescent image of a protein.

After the protein has been dyed using the fluorescent dye, the dyed protein is preferably decolorized using a decolorizing solution.

In a preferred aspect of the present invention, the fluorescent dye for dyeing a protein is most effectively stimulated with a stimulating ray having a wavelength between 440 nm to 500 nm and emits fluorescent light whose peak wavelength ranges from 560 nm to 620 nm. Illustrative examples of such fluorescent dye for dyeing a protein include SYPRO Orange and SYPRO Red manufactured and sold by Molecular Probes Inc., Oregon, the U.S.A.

In another preferred aspect of the present invention, the fluorescent dye for dyeing a protein is most effectively stimulated with a stimulating ray having a wavelength between 510 nm to 580 nm and emits fluorescent light whose peak wavelength ranges from 600 nm to 660 nm. Examples of such fluorescent dye for dyeing a protein include SYPRO Red manufactured and sold by Molecular Probes Inc., Oregon, the U.S.A.

In the present invention, the fixing solution contains 1 to 15 volume (v/v) % of acetic acid and 5 to 75 volume (v/v) % of methanol or ethanol, preferably, 5 to 10 volume (v/v) % of acetic acid and 30 to 75 volume (v/v) % of methanol or ethanol, more preferably, 7 to 8 volume (v/v) % of acetic acid and 45 to 55 volume (v/v) % of methanol or ethanol.

In the present invention, the time period a protein is required to be in contact with a fixing solution in order to fix an electrophoresed protein is from 1 to 60 minutes, preferably, 5 to 30 minutes, more preferably, 5 to 15 minutes.

In the present invention, the time period required for dyeing an electrophoresed protein with fluorescent dye for dyeing a protein is from 10 minutes to 8 hours, preferably, 1 to 5 hours, more preferably, 1 to 2 hours.

The decolorizing solution used for decolorizing a protein dyed with fluorescent dye for dyeing a protein contains 1 to 15 volume (v/v) % of acetic acid and 1 to 30 volume (v/v) % of methanol or ethanol, preferably, 5 to 10 volume (v/v) % of acetic acid and 3 to 10 volume (v/v) % of methanol or ethanol, more preferably, 7 to 8 volume (v/v) % of acetic acid and 3 to 5 volume (v/v) % of methanol or ethanol.

In the present invention, the time period a protein is required to be in contact with a decolorizing solution in order to decolorize a dyed protein is 1 to 30 minutes, preferably, 1 to 10 minutes, more preferably, 5 to 10 minutes.

Examples and comparative examples will be now described for further clarifying the technical advantages of the present invention.

### EXAMPLE 1

A dilution series of eleven diluted solutions of bovine serum albumin (hereinafter referred to as “BSA”) was produced in the following manner.

A tris-sodium dodecyl sulfide-β mercaptoethanol buffer having the following composition was used as a dilution solution.

| | |
|---|---|
| tris (hydroxymethyl) aminomethane-HCl | 0.25 mol/liter |
| sodium dodecyl sulfide (SDS) | 2% (w/v) |
| | (2 g/liter) |
| glycerol | 30% (v/v) |
| | (300 cc/liter) |
| β mercaptoethanol (β ME) | 10% (v/v) |
| | (100 cc/liter) |
| bromide phenol blue (BPB) | 0.01% (v/v) (pH 6.8) |
| | (0.1 cc/liter) |

Eleven solutions were prepared to contain 10 ug of BSA, 1 ug of BSA, 100 ng of BSA, 50 ng of BSA, 20 ng of BSA, 10 ng of BSA, 5 ng of BSA, 1 ng of BSA, 500 pg of BSA and 200 pg of BSA.

A gel whose gel concentration changes from 4 to 10% was selected and was set in a vertical type cassette electrophoresis tank.

Then, as an electrophoresis buffer, sodium dodecyl sulfide-tris-glycine buffer having the following composition was poured into the electrophoresis tank.

| | |
|---|---|
| tris (hydroxymethyl) aminomethane | 0.025 mol/liter |
| glycine | 0.192 mol/liter |
| sodium dodecyl sulfide | 2% (w/v) (pH 8.5) |
| | (20 g/liter) |

Then, each solution was poured into one of wells formed on the gel and electrophoresis was carried out with the electrical current applied to the gel set at 20 mA.

After the completion of the electrophoresis, the gel was removed from the electrophoresis tank and placed in a tray. Then, a fixing solution containing 7.5 volume (v/v) % of acetic acid and 50 volume (v/v) % of methanol was poured into the tray and the gel was immersed for ten minutes, thereby fixing BSA onto the gel.

The fixing solution was then discharged from the tray and a dyeing solution was poured into the tray. The dyeing solution was prepared by diluting fluorescent dye for dyeing a protein, SYPRO Orange, with 7.5 volume (v/v) % of an acetic acid solution in a volume ratio of 1 to 5000 and the BSA was dyed for two hours.

After the dyeing, the surface of the gel was scanned with an SHG laser beam having a wavelength of 473 nm. Fluorescent light emitted from SYPRO Orange upon being irradiated was collected by a light collecting guide made of acrylic resin and was photoelectrically detected by a photomultiplier, thereby producing a fluorescent image of the BSA on the screen of a CRT. When the thus produced fluorescent image of the BSA was visually observed to determine the detection limit of the dilution series, the BSA of 500 pg series could be detected since background noise was low and the sharpness of the image was high.

### EXAMPLE 2

A fluorescent image of BSA was produced in a similar manner to EXAMPLE 1 except that after the BSA was dyed with SYPRO Orange and before the scanning with an SHG laser beam having a wavelength of 473 nm, a decolorizing solution containing 7.5 volume (v/v) % of acetic acid and 5 volume (v/v) % of methanol was poured into the tray and the tray was gently shaken for five minutes, thereby decolorizing the BSA. When the thus produced fluorescent image of the BSA was visually observed to determine the detection limitat of the dilution series, the BSA of 200 pg series could be detected since background noise was much lower than in EXAMPLE 1 and the sharpness of the image was high.

### Comparative Example 1

A fluorescent image of BSA was produced in a similar manner to EXAMPLE 1 except that after the completion of the electrophoresis operation, the gel was removed from the electrophoresis tank and the BSA was dyed with SYPRO Orange without being immersed in the fixing solution. When the thus produced fluorescent image of BSA was visually observed to determine the detection limitat of the dilution series, only the BSA of 1 ng series could be detected since background noise was high and the sharpness of the image was low.

### EXAMPLE 3

A fluorescent image of BSA was produced in a similar manner to EXAMPLE 1 except that the BSA on the gel was dyed using SYPRO Red instead of SYPRO Orange as a fluorescent dye for dyeing a protein and that the surface of the gel was scanned with an SHG laser beam having a wavelength of 532 nm. The fluorescent light emitted from SYPRO Red was photoelectrically detected, thereby producing a fluorescent image of the BSA. When the thus produced fluorescent image of the BSA was visually observed to determine the detection limitat of the dilution series, the BSA of 500 pg series could be detected since background noise was low and the sharpness of the image was high.

### EXAMPLE 4

A fluorescent image of BSA was produced in a similar manner to EXAMPLE 1 except that after the BSA was dyed with SYPRO Red and before the scanning with an SHG laser beam having a wavelength of 532 nm, a decolorizing solution solution containing 7.5 volume (v/v) % of acetic acid and 5 volume (v/v) % of methanol was poured into the tray and the tray was gently shaken for five minutes, thereby decolorizing BSA. When the thus produced fluorescent image of the BSA was visually observed to determine the detection limitat of the dilution series, the BSA of 200 pg series could be detected since background noise was much lower than in EXAMPLE 3 and the sharpness of the image was high.

### Comparative Example 2

A fluorescent image of BSA was produced in a similar manner to EXAMPLE 3 except that after the completion of the electrophoresis operation, the gel was removed from the electrophoresis tank and the BSA was dyed with SYPRO Red without being immersed in the fixing solution. When the thus produced fluorescent image of BSA was visually observed to determine the detection limit of the dilution series, only the BSA of 1 ng series could be detected, since background noise was high and the sharpness of the image was also low.

As apparent from Examples 1 and 2, Comparative Example 1, Examples 3 and 4 and Comparative Example 2, only the BSA of 1 ng series could be detected in Comparative Examples 1 and 2 according to the conventional protein dyeing and detecting method. To the contrary, in Examples 1 and 3, wherein BSA was fixed prior to dyeing with SYPRO Orange and SYPRO Red, the background noise in the image was low and the sharpness of the image was high, whereby the detection sensitivity was improved to enable detection of the BSA of 500 pg series. Further, in Examples 2 and 4 wherein the decolorizing operation was carried out after the dyeing with SYPRO Orange and SYPRO Red, the background noise was much lower than that in Examples 1 and 3 and the sharpness of an image was high, whereby the BSA of 200 pg series could be detected. It was thus found that the present invention markedly improves the detection sensitivity of a protein dyeing and detecting method using SYPRO Orange or SYPRO Red.

The present invention has thus been shown and described with reference to specific examples. However, it should be noted that the present invention is in no way limited to the details of the described examples but changes and modifications may be made without departing from the scope of the appended claims.

According to the present invention, it is possible to provide a protein dyeing and detecting method which can produce a fluorescent image of a protein having high sharpness and low background noise by dyeing the electrophoresed protein with fluorescent dye for dyeing a protein, irradiating it with a stimulating ray and detecting fluorescent light emitted therefrom upon being irradiated and can detect locational information of the protein with high sensitivity.

1. A protein dyeing and detecting method comprising steps of fixing a protein electrophoresed on a gel on the gel using a fixing solution, dyeing the fixed protein with fluorescent dye for dyeing a protein which has a property of mainly acting on sodium dodecyl sulfide (SDS)-protein complex to dye a protein, irradiating the dyed protein with a stimulating ray and detecting fluorescent light emitted from the protein upon being irradiated to produce a fluorescent image of a protein.

2. A protein dyeing and detecting method in accordance with claim 1 which further includes a step of decolorizing the dyed protein using a decolorizing solution after the protein has been dyed using the fluorescent dye and wherein the fluorescent image of a protein is produced by irradiating the protein with a stimulating ray after the decolorizing and detecting fluorescent light emitted from the protein upon being irradiated.

3. A protein dyeing and detecting method in accordance with claim 1 wherein the fluorescent dye for dyeing a protein is most effectively stimulated with a stimulating ray having a wavelength between 440 nm to 500 nm and emits fluorescent light whose peak wavelength ranges from 560 nm to 620 nm.

4. A protein dyeing and detecting method in accordance with claim 2 wherein the fluorescent dye for dyeing a protein is most effectively stimulated with a stimulating ray having a wavelength between 440 nm to 500 nm and emits fluorescent light whose peak wavelength ranges from 560 nm to 620 nm.

5. A protein dyeing and detecting method in accordance with claim 1 wherein the fluorescent dye for dyeing a protein is most effectively stimulated with a stimulating ray having a wavelength between 510 nm to 580 nm and emits fluorescent light whose peak wavelength ranges from 600 nm to 660 nm.

6. A protein dyeing and detecting method in accordance with claim 2 wherein the fluorescent dye for dyeing a protein is most effectively stimulated with a stimulating ray having a wavelength between 510 nm to 580 nm and emits fluorescent light whose peak wavelength ranges from 600 nm to 660 nm.

7. A protein dyeing and detecting method in accordance with claim 1 wherein the fixing solution contains 1 to 15 volume (v/v) % of acetic acid and 5 to 75 volume (v/v) % of methanol or ethanol.

8. A protein dyeing and detecting method in accordance with claim 2 wherein the fixing solution contains 1 to 15 volume (v/v) % of acetic acid and 5 to 75 volume (v/v) % of methanol or ethanol.

9. A protein dyeing and detecting method in accordance with claim 3 wherein the fixing solution contains 1 to 15 volume (v/v) % of acetic acid and 5 to 75 volume (v/v) % of methanol or ethanol.

10. A protein dyeing and detecting method in accordance with claim 4 wherein the fixing solution contains 1 to 15 volume (v/v) % of acetic acid and 5 to 75 volume (v/v) % of methanol or ethanol.

11. A protein dyeing and detecting method in accordance with claim 5 wherein the fixing solution contains 1 to 15 volume (v/v) % of acetic acid and 5 to 75 volume (v/v) % of methanol or ethanol.

12. A protein dyeing and detecting method in accordance with claim 6 wherein the fixing solution contains 1 to 15 volume (v/v) % of acetic acid and 5 to 75 volume (v/v) % of methanol or ethanol.

13. A protein dyeing and detecting method in accordance with claim 7 wherein time period a protein is required to be in contact with a fixing solution in order to fix an electrophoresed protein is from 1 to 60 minutes.

14. A protein dyeing and detecting method in accordance with claim 8 wherein time period a protein is required to be in contact with a fixing solution in order to fix an electrophoresed protein is from 1 to 60 minutes.

15. A protein dyeing and detecting method in accordance with claim 9 wherein time period a protein is required to be in contact with a fixing solution in order to fix an electrophoresed protein is from 1 to 60 minutes.

16. A protein dyeing and detecting method in accordance with claim 10 wherein time period a protein is required to be in contact with a fixing solution in order to fix an electrophoresed protein is from 1 to 60 minutes.

17. A protein dyeing and detecting method in accordance with claim 11 wherein time period a protein is required to be in contact with a fixing solution in order to fix an electrophoresed protein is from 1 to 60 minutes.

18. A protein dyeing and detecting method in accordance with claim 12 wherein time period a protein is required to be in contact with a fixing solution in order to fix an electrophoresed protein is from 1 to 60 minutes.

19. A protein dyeing and detecting method in accordance with claim 2 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

20. A protein dyeing and detecting method in accordance with claim 4 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

21. A protein dyeing and detecting method in accordance with claim 6 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

22. A protein dyeing and detecting method in accordance with claim 8 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

23. A protein dyeing and detecting method in accordance with claim 10 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

24. A protein dyeing and detecting method in accordance with claim 12 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

25. A protein dyeing and detecting method in accordance with claim 14 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

26. A protein dyeing and detecting method in accordance with claim 16 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

27. A protein dyeing and detecting method in accordance with claim 18 wherein the decolorizing solution for decolorizing a protein dyed with fluorescent dye for dyeing a protein contains 1 to 15 volume (v/v) % of acetic acid and 1 to 30 volume (v/v) % of methanol or ethanol.

28. A protein dyeing and detecting method in accordance with claim 19 wherein time period a protein is required to be in contact with a decolorizing solution in order to decolorize a dyed protein is 1 to 30 minutes.

29. A protein dyeing and detecting method in accordance with claim 20 wherein time period a protein is required to be in contact with a decolorizing solution in order to decolorize a dyed protein is 1 to 30 minutes.

30. A protein dyeing and detecting method in accordance with claim 21 wherein time period a protein is required to be in contact with a decolorizing solution in order to decolorize a dyed protein is 1 to 30 minutes.

31. A protein dyeing and detecting method in accordance with claim 22 wherein time period a protein is required to be in contact with a decolorizing solution in order to decolorize a dyed protein is 1 to 30 minutes.

32. A protein dyeing and detecting method in accordance with claim 23 wherein time period a protein is required to be in contact with a decolorizing solution in order to decolorize a dyed protein is 1 to 30 minutes.

33. A protein dyeing and detecting method in accordance with claim 24 wherein time period a protein is required to be in contact with a decolorizing solution in order to decolorize a dyed protein is 1 to 30 minutes.

34. A protein dyeing and detecting method in accordance with claim 25 wherein time period a protein is required to be in contact with a decolorizing solution in order to decolorize a dyed protein is 1 to 30 minutes.

35. A protein dyeing and detecting method in accordance with claim 26 wherein time period a protein is required to be in contact with a decolorizing solution in order to decolorize a dyed protein is 1 to 30 minutes.

36. A protein dyeing and detecting method in accordance with claim 27 wherein time period a protein is required to be in contact with a decolorizing solution in order to decolorize a dyed protein is 1 to 30 minutes.
